(19) United States
(12) Patent Application Publication
(10) Pub. No.: US 2025/0314520 A1
(43) Pub. Date: Oct. 9, 2025

(54) SENSOR CIRCUIT FOR DETECTING REFRIGERANT AND RELATED METHOD

(71) Applicant: Mitsubishi Electric US, Inc., Cypress, CA (US)

(72) Inventors: Joseph Paul BUSH, Lawrenceville, GA (US); Dan Mihai MANOLE, Suwanee, GA (US)

(21) Appl. No.: 18/627,102

(22) Filed: Apr. 4, 2024

(51) Int. Cl. G01F 23/60; F25B 49/00

(52) U.S. Cl. CPC G01F 23/60; F25B 49/005; F25B 2500/222; F25B 2700/04

(57) ABSTRACT

A sensor circuit is provided, including a float sensor and a refrigerant sensor. The float sensor includes a float housing a float, and a switch. The float housing has an opening on a first side wall and can contain liquid that flows into and out of the float housing through the opening. The float is in the float housing and rises or falls based on a level of liquid in the float housing. The switch is connected to the float and transmits a signal when the liquid in the float housing rises to a predetermined height. The refrigerant sensor circuit is connected to the float sensor, includes a refrigerant sensor, and detects a level of refrigerant in second air formed at least in part from first air in the float housing. The refrigerant pipe is connected to a second wall of the float housing fully above the predetermined height.

### TECHNICAL FIELD

The disclosed systems and methods relate generally to a circuit and method for detecting refrigerant in an air-conditioner. Specifically, the sensor circuit is a unified water level and refrigerant sensor that can take air proximate to a float sensor attached to a drain pan in the air-conditioner and provide that air to a refrigerant sensor. Since the air proximate to the float sensor is from an area in an air conditioner in which refrigerant leaks are most likely to occur, this can give an accurate assessment of whether a refrigerant leak has occurred.

### BACKGROUND

An air conditioner will generally include a heat exchanger, which may include coils through which a refrigerant flows, e.g., an A-coil. One common type of refrigerant used by such air conditioners is an A2L refrigerant. The designation A2L indicates that the refrigerant is non-toxic (A), is flammable (2), and has a low burning velocity (L). Other refrigerants may also be used, with varying parameters.

In the air conditioner, the refrigerant is cooled in a cooling operation and heated in a heating operation, and air is passed over the coils. This causes the air to exchange heat with the refrigerant passing through the coils and be either heated or cooled depending upon the type or operation being performed.

During heating and cooling operations, a coil-based heat exchanger can leak refrigerant into the air surrounding the heat exchanger. This often happens where pipes are brazed, though other types of leaks are also possible.

Leaks in a heat exchanger coil are undesirable for several possible reasons. First, if the refrigerant used in air conditioners is toxic, leaked refrigerant may cause a health hazard to people in the building containing the air conditioner. Leaked refrigerant from the air conditioner can be blown into the area being heated or cooled and may be breathed by those inside that the building containing the air-conditioner. Second, if the refrigerant is flammable, leaked refrigerant can increase the fire risk in the building containing the air-conditioner. Third, since the proper operation of a coil-based heat exchanger requires sufficient refrigerant pass through the coils, a leakage of refrigerant can cause the air conditioner to function less efficiently. Fourth, leaked refrigerant must be replaced, meaning that a refrigerant leak will result in additional costs for operating the air conditioner.

As a result, many air conditioners contain refrigerant sensors to detect refrigerant leaks so that they can be identified and corrected quickly, and so avoid or minimize the problems identified above.

However, it is also desirable to make air conditioners as small as possible to minimize the amount of space they take up in a building. It is therefore desirable to provide a refrigerant sensor that takes up as little space as possible.

### SUMMARY OF THE INVENTION

According to one or more embodiments, a sensor circuit is provided, comprising: a float sensor including a float housing having an opening on a first side wall, the float housing being configured to contain a liquid, such that the liquid can flow into and out of the float housing through the opening, a float located in the float housing and configured to rise or fall based on a level of the liquid in the float housing, and a switch connected to the float and configured to transmit an air-conditioner shut-down signal when the liquid in the float housing rises to a predetermined height; and a refrigerant sensor circuit connected to the float sensor, the refrigerant sensor circuit including a refrigerant sensor and being configured to detect a level of refrigerant in second air formed at least in part from first air in the float housing, wherein the refrigerant pipe is connected to a second wall of the float housing at a location fully above the predetermined height.

The first side wall of the float housing and the second side wall of the float housing may be the same or different from each other.

The first air may be provided to the refrigerant sensor as the second air.

The refrigerant sensor circuit may further include a refrigerant pipe connected at a first end to a second wall of the float housing and at a second end to the refrigerant sensor, the refrigerant pipe being configured to allow the first air from the float housing to pass through to the refrigerant sensor.

The sensor circuit may further comprise: an air pipe connected at a first end to the refrigerant pipe such that the first air passing into the refrigerant pipe from the float sensor and third air passing into the refrigerant pipe through the air pipe are mixed in the refrigerant pipe to create the second air prior to the second air being provided to the refrigerant sensor.

The sensor circuit may further comprise: an air pipe connected at a first end to the refrigerant pipe such that a portion of the first air passing into the refrigerant pipe from the float sensor is passed as third air through the air pipe, and a remainder of the first air after the third air is removed forms the second air prior to the second air being provided to the refrigerant sensor.

The float sensor may further include an overflow pipe connected at a first end to the first side wall of the float housing such that the liquid can flow from the overflow pipe into and out of the float housing through the opening.

A second end of the overflow pipe may be connected to an overflow port in a drain pan in an air conditioner.

The drain pan may be contained inside an air-conditioner housing, and the sensor circuit may be located outside of the air-conditioner housing.

A sensor circuit may also be provided, comprising: a float sensor including a float housing having an opening on a first side wall, the float housing being configured to contain a liquid, a float located in the float housing and configured to rise or fall based on a level of the liquid in the float housing, and a switch connected to the float and configured to transmit an air-conditioner shut-down signal when the liquid in the float housing rises to a predetermined height; a three-way connection pipe connected at a first end to the first side wall of the float housing such that the liquid and first air can flow from the overflow pipe into the float housing through the opening; and a refrigerant sensor connected to a third end of the three-way connection pipe and configured to detect a level of refrigerant in third air formed at least in part by the first air in the three-way connection pipe, wherein an opening from the third end of the three-way connection pipe is located above the predetermined height.

The three-way connection pipe may include a three-way main pipe having first, second, and third ends, and a float-switch pipe connected between the second end of the three-way main pipe and the first side wall of the float housing such that the liquid can flow from the float-switch pipe into the float housing through the opening.

The three-way connection pipe may further include a refrigerant-sensor pipe connected between the third end of the three-way main pipe and the refrigerant sensor such that the first air in the three-way connection pipe is passed through the refrigerant-sensor pipe to the refrigerant sensor.

The three-way connection pipe may further include a three-way main pipe having first, second, and third ends, and a refrigerant-sensor pipe connected between the third end of the three-way main pipe and the refrigerant sensor such that the first air in the three-way connection pipe is passed through the refrigerant-sensor pipe to the refrigerant sensor.

The third end of the three-way connection pipe may be connected to an overflow port in a drain pan in an air conditioner.

The drain pan may be contained inside an air-conditioner housing, and the sensor circuit may be located outside of the air-conditioner housing.

The sensor circuit may further comprise: an air pipe connected at a first end to the three-way connection pipe such that the first air passing into the three-way connection pipe and third air passing into the refrigerant pipe through the air pipe are mixed in the refrigerant pipe to create the second air prior to the second air being provided to the refrigerant sensor.

A method of detecting refrigerant is provided, comprising: passing overflow water and first air from a drain pan in an air conditioner to a float sensor; diverting a portion of the first air to a refrigerant sensor to form at least part of second air in the refrigerant sensor after the air exits the drain pan; determining at the refrigerant sensor that a level of refrigerant in the second air is above a concentration threshold; and transmitting a leakage signal from the refrigerant sensor after the refrigerant sensor determines that the level of refrigerant in the second air is above the concentration threshold.

The method may further comprise passing third air from a portion of the air conditioner downstream of the drain pan to the refrigerant sensor; and mixing the first air and the third air to form the second air.

The passing of the third air from the portion of the air conditioner downstream of the drain pan to the refrigerant sensor may be accomplished based on a third air pressure of the third air in the portion of the air conditioner downstream of the drain pan being greater than a first air pressure of the first air provided from the drain pan.

The mixing of the first air and the third air to form the second air may be performed in a pipe between the drain pan, refrigerant sensor, and the portion of the air conditioner downstream of the drain pan.

The pipe may be a three-way connection pipe between the drain pan, refrigerant sensor, and the portion of the air conditioner downstream of the drain pan.

The mixing the first air and the third air to form the second air may be performed proximate to the refrigerant sensor.

The method may further comprise: drawing a portion of the first air from the refrigerant sensor to a portion of the air conditioner downstream of the drain pan.

The passing of the portion of the first air from the refrigerant sensor to the portion of the air conditioner downstream of the drain pan may be accomplished based on a third air pressure in the portion of the air conditioner downstream of the drain pan being lower than a first air pressure of the first air provided from the drain pan.

In the operation of diverting a portion of the first air to the refrigerant sensor, the portion of the first air may be diverted to the refrigerant sensor after the portion of first air enters the float sensor.

The operation of passing the overflow water and the first air from the drain pan to the float sensor may further include passing the overflow water and the first air from the drain pan to a three-way connection pipe, and passing the first water and the overflow air from the three-way connection pipe to the float sensor, and in the operation of diverting the portion of the first air to the refrigerant sensor, the first air may be diverted from the three-way connection pipe to the refrigerant sensor before the first air is provided to the float sensor.

### BRIEF DESCRIPTION OF THE DRAWINGS

The accompanying figures, where like reference numerals refer to identical or functionally similar elements and which together with the detailed description below are incorporated in and form part of the specification, serve to further illustrate an exemplary embodiment and to explain various principles and advantages in accordance with the present disclosure.

FIG. 1 is a plan view of a drain pan for an air conditioner according to disclosed embodiments;

FIG. 2 is a side view of the drain pan of FIG. 1 according to disclosed embodiments;

FIG. 3 is a plan view of a float sensor for use in an air conditioner according to disclosed embodiments;

FIG. 4 is a top view of a sensor circuit connected to a drain pan according to disclosed embodiments;

FIG. 5 is a side view of the sensor circuit of FIG. 4 at a first water level according to disclosed embodiments;

FIG. 6 is a side view of the sensor circuit of FIG. 4 at a second water level according to disclosed embodiments;

FIG. 7 is a side view of a sensor circuit that is tilted at a positive angle according to disclosed embodiments;

FIG. 8 is a top view of a sensor circuit connected to a drain pan according to disclosed embodiments;

FIG. 9 is a side view of the sensor circuit of FIG. 8 at a first water level according to disclosed embodiments;

FIG. 10 is a diagram of an air conditioner including the a sensor circuit according to disclosed embodiments;

FIG. 11 is a diagram of an air conditioner including the a sensor circuit according to alternate disclosed embodiments;

FIG. 12 is a diagram of an air conditioner including the a sensor circuit according to additional alternate disclosed embodiments;

FIG. 13 is a flow chart of a method of sensing a refrigerant according to disclosed embodiments;

FIG. 14 is a flow chart of a method of sensing a refrigerant according to alternate disclosed embodiments; and

FIG. 15 is a flow chart of a method of sensing a refrigerant according to other alternate disclosed embodiments.

### DETAILED DESCRIPTION

The instant disclosure is provided to further explain in an enabling fashion the best modes of performing one or more embodiments of the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

### Air Conditioner Drain Pan

If an air conditioner is performing a cooling operation in which the refrigerant is cooled, the exchange of heat between the air and the refrigerant can cause moisture to condense from the air and form on the low-temperature coils. This condensation will then drip off the coils toward the bottom of the air conditioner. As a result, an air conditioner with a coil heat exchanger will generally have a drain pan located beneath the heat exchanger to collect the condensed water that drips from the heat exchanger coils.

Such a drain pan will have at least one primary drain opening (typically just referred to simply as a primary drain) through which the water collected in the drain pan can exit the drain pan. Many drain pans will also have an overflow drain located above a primary drain that will allow water to exit the drain pan if the level of water in the drain pan gets too high. Such an overflow drain is often connected to a float switch that measures the level of water in the drain pan and issues a shut-off command to the air conditioner if the water level gets too high. The shut-off command will stop the distribution of refrigerant through the heat exchanger, thereby preventing additional water from condensing onto the heat exchange coils and dripping into the drain pan. This will give time for water to properly drain out of the drain pan or for a user to clear a clog in the drain pan's primary drain.

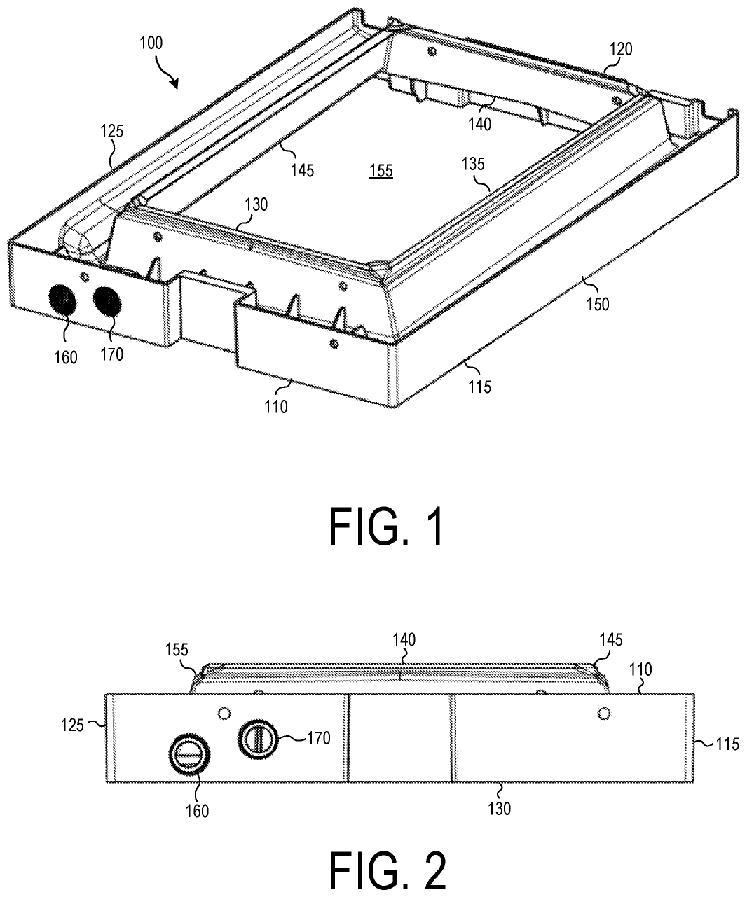

FIG. 1 is a plan view of a drain pan 100 for an air conditioner according to disclosed embodiments. Specifically, this exemplary drain pan 100 is a drain pan for a vertically oriented air conditioner in which air is circulated through a heat exchanger vertically.

As shown in FIG. 1, the drain pan 100 includes first, second, third, and fourth outer drain pan walls 110, 115, 120, 125, first, second, third, and fourth inner drain pan walls 130, 135, 140, 145, a drain pan bottom 150, an opening 155 between the inner drain pan walls 140-155, a primary drain 160, and an overflow drain 170.

The first, second, third, and fourth outer drain pan walls 110, 115, 120, 125 form an outer perimeter of the drain pan 100. The first drain pan wall 110 contains the primary drain 160 and the overflow drain 170, although this is by way of example only. The primary and overflow drains 160, 170 could be on different outer drain pan walls 110-125 in alternate embodiments. In addition to the drains 160, 170, one or more of the outer drain pan walls 110-125 may include a cut-out on the top of the drain pan wall 110-125 to channel overflow water that rises above the overflow drain 170.

The first, second, third, and fourth inner drain pan walls 130, 135, 140, 145 form an inner perimeter of the drain pan 100. In various embodiments, the inner drain pan walls 130-145 can be taller than the outer drain pan walls 110-125 and may be slanted towards the opening 155 to channel dripping water into the drain pan 100.

The drain pan bottom 150 is located between the outer drain pan walls 110-125 and the inner drain pan walls 130-145 and serves along with the outer drain pan walls 110-125 and the inner drain pan walls 130-145 to define a basin for containing dripping water.

The opening 135 is located between the inner drain pan walls 140-155 and allows for the passage of air through the space containing the drain pan 100.

The primary drain 160 is located on the first outer drain pan wall 110 and serves as an avenue for water in the drain pan 100 to move out of basin formed by the outer drain pan walls 110-125, the inner drain pan walls 130-145, and drain pan bottom 150.

The overflow drain 170 is also located on the first outer drain pan wall 110 and also serves as an avenue for water in the drain pan 100 to move out of basin formed by the outer drain pan walls 110-125, the inner drain pan walls 130-145, and drain pan bottom 150. However, the overflow drain 170 is located at a height higher than that of the primary drain 160. As a result, water will flow out of the primary drain 160 first and will only enter the overflow drain 170 when it has at least partially filled the primary drain 160.

FIG. 2 is a side view of the drain pan 100 of FIG. 1 according to disclosed embodiments. As shown in FIG. 2, the overflow drain 170 is located at a higher elevation than the primary drain 160. This provides that the overflow drain 170 will only receive water when the primary drain 160 is partially filled. Likewise, the overflow drain 170 will only fill up after the primary drain 160 fills up.

In the embodiment of FIG. 2, the primary drain 160 and the overflow drain 170 overlap each other in height, i.e., the top half of the primary drain 160 is at the same height as the lower half of the overflow drain 170. However, this is by way of example only. Alternate embodiments can vary the exact position of the primary drain 160 and the overflow drain 170 so long as the overflow drain 170 is at least partially at a higher height in the drain pan 100 than the primary drain 160.

An alternate embodiment of the drain pan could do away with the inner drain pan walls 130-145 and leave only the outer drain pan walls 110-125. In such an embodiment the bottom would extend across the entire area between the outer drain pan walls 110-125.

### Float Sensor

In order to determine when the drain pan 100 is about to overflow, a float sensor can be connected to the drain pan 100. The float sensor is typically connected to the overflow drain 170 and is attached outside of an air conditioning housing. The float sensor is configured to receive water from the overflow drain 170 and to determine when the height of the water in the drain pan reaches a set threshold level. The float sensor can then send a shut-off signal to an air conditioner controller (not shown) when the water reaches the threshold level, instructing the air conditioner controller to suspend operation of the air conditioner. The float sensor can be further configured to instruct the air conditioner controller to resume air conditioning operations when the height of the water in the drain pan falls below the set threshold level.

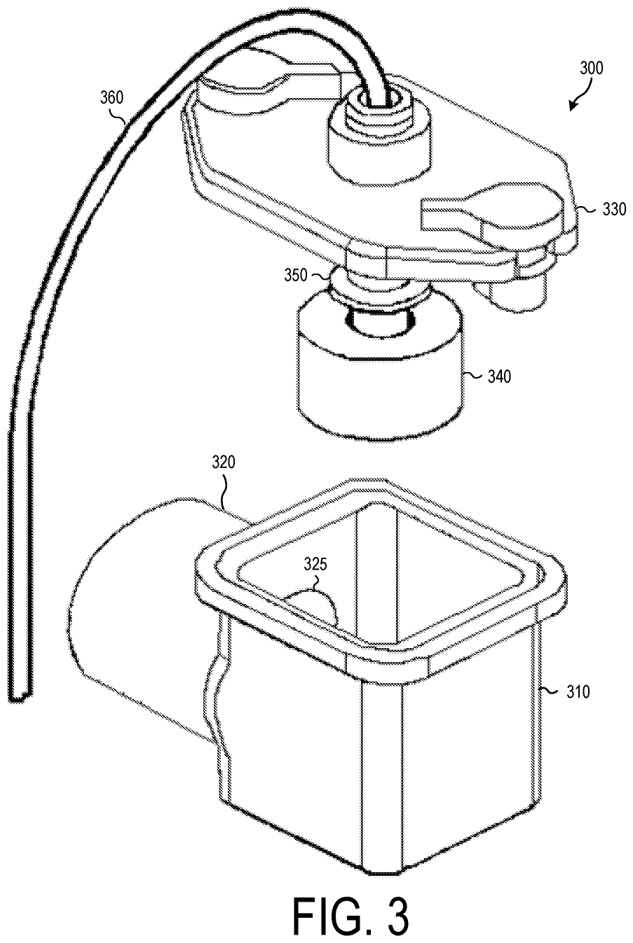

FIG. 3 is a plan view of a float sensor 300 for use in an air conditioner according to disclosed embodiments. As shown in FIG. 3, the float sensor 300 includes a float housing 310, an overflow pipe 320, a float sensor top 330, a float 340, a float switch 350, and a signal line 360.

The float housing 310 is formed of a plurality of walls and a bottom that form a watertight container to contain water received from an overflow drain 170 in a drain pan 100.

The overflow pipe 320 is provided to connect the float housing 310 to the overflow pipe 170. It is connected at the float housing 310 via an opening 325 in a first wall of the float housing 310. Water received from the overflow pipe 170 can thus pass into the float housing 310 through the opening 325.

The float sensor top 330 is provided on top of float housing 310 such that the float housing 310 can be sealed.

The float 340 is provided inside the float housing 310 and connected to the float sensor top 330. The float 340 is configured to rise and fall along with the water in the float housing 310, and to either indicate its relative level to the float switch 350, or to indicate when the level of the float 340 exceeds a predetermined level.

The float switch 350 is attached to the float sensor top 330 and serves to determine when the float 340 exceeds the predetermined level. When the float switch 350 determines that the float has exceeded predetermined level, it sends a shut-off signal to the air conditioner controller instructing the air conditioner controller to shut off the operation of the heat exchanger in the air conditioner.

The signal line 360 connects the float switch 350 to the air conditioner controller and carries the shut-off signal and any other signals or commands required between the float switch and the air conditioner controller.

In the embodiment shown in FIG. 3, the float switch 350 includes a cylindrical rod and a cylindrical plate surrounding the cylindrical rod at a set level corresponding to the threshold level. The float is a cylindrical structure that is lighter than water and surrounds the cylindrical rod at a level lower than the cylindrical plate. As the level of water in the float housing 310 rises, the float 340 also rises. When the float 340 reaches the level of the cylindrical plate, it will push the plate cylindrical plate up, turning on the float switch 350 and indicating that the level of water in the float housing 310 has risen to the threshold level. This pushing can be through direct contact between the float 340 and the cylindrical plate or magnetic interaction between the float 340 and the plate. Alternate designs for the float switch 350 can also be used.

As the water in the float housing 310 recedes, the float 340 will drop in level and if it drops below the threshold level the float 340 will fall below the level of the cylindrical plate and the float switch will turn off, causing the float switch 350 to stop sending the shut-off signal.

In this way, float sensor 300 will send a shut-off signal via the signal line 360 when the water level in the float housing 310 is above the threshold level and will not send the shut-off signal via the signal line 360 when the water level in the float housing is below the threshold level.

### Sensor Circuit—First Embodiment

Because space for an air conditioner is often at a premium and it is generally desirable to keep the cost of the air conditioner low, a refrigerant sensor can be integrated with the float sensor to minimize expense and size for the refrigerant sensor.

In addition, some refrigerant sensors are sensitive to temperature. Since the temperature inside an air conditioner varies dramatically, particularly next to the heat exchanger in the air conditioner, it can be beneficial to place the refrigerant sensor in a place where the temperature variation will be minimized. The float sensor 300 is typically located outside of the air conditioner housing, which means its temperature variation is generally less than inside the air conditioner housing.

As a result, it can be desirable to combine a float sensor 300 (i.e., water level sensor) and a refrigerant sensor in a single unit. This can reduce cost and installation time and can improve the accuracy of the refrigerant sensor. This configuration also allows a single opening in the air conditioning housing (i.e., an opening to allow access to the overflow drain 170) to be used for both a water level sensor and a refrigerant sensor.

The use of integrated water level/refrigerant sensor also allows the use of a refrigerant sensor in different air-conditioner configurations, e.g., an upflow configuration in which air passes through the air conditioner from bottom to top, a downflow configuration in which air passes through the air conditioner from top to bottom, and a horizontal configuration in which air passes through the air conditioner from side-to-side.

Furthermore, by making the refrigerant sensor integral with the float sensor 300, the refrigerant sensor will be located outside of an air conditioner housing, which will allow for ease of maintenance or retrofitting since the refrigerant sensor can be easily accessed or replaced without removing any panels or any opening covers.

In addition, it is generally desirable to place a refrigerant sensor as close as possible to where refrigerant leaks are most likely to occur. When an air conditioner contains a heat exchanger such as an A-coil, one area that is likely to have a refrigerant leak is an area near the heat exchanger, particularly where pipes in the heat exchanger have been brazed. The drain pan 100 in such units is generally close to such an area. Therefore, drawing air from near the drain pan 100 to test for refrigerant allows for a more accurate determination as to whether a refrigerant leak has occurred.

In alternate embodiments, a sensor circuit could also include other useful detectors such as smoke detectors or indoor air quality (IAQ) sensors.

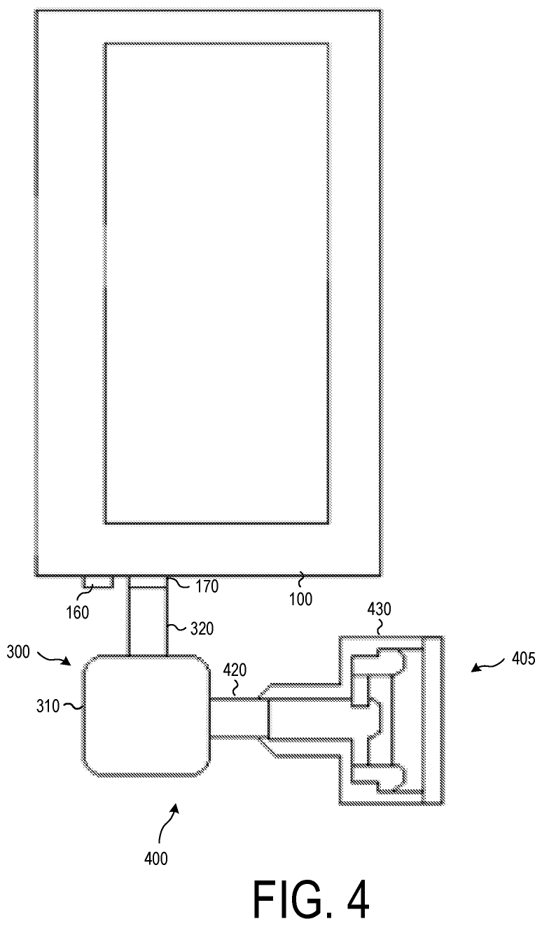

FIG. 4 is a top view of a sensor circuit 400 connected to a drain pan 100 according to disclosed embodiments. As shown in FIG. 4, the drain pan 100 includes a primary drain 160 and an overflow drain 170. The sensor circuit 400 includes a float sensor 300 and a refrigerant sensor circuit 405. The float sensor 300 corresponds to the float sensor of FIG. 3 and its description will be limited for brevity. The refrigerant sensor circuit 405 includes a refrigerant pipe 420 and a refrigerant sensor 430.

The float housing 310 of the float sensor 300 is connected to the overflow drain 170 of the drain pan 100 via the overflow pipe 320. This allows water from the basin of the drain pan 100 to pass to and from the float housing 310 via the overflow drain 170 and the overflow pipe 320. When the water in the basin of the drain pan 100 rises to the level of the overflow drain 170, water will pass through the overflow drain 170 and the overflow pipe 320 into the float housing 310. Likewise, as water drops below the level of the overflow drain 170, water will pass from the float housing 310 through overflow drain 170 and the overflow pipe 320 back into the drain pan 100.

The level of the water in the float housing 310 will correspond to the level of the water in the basin of the drain pan 100. This will allow the float sensor 300 to detect the level of water in the basin of the drain pan 100 and send a shut-off signal when the level of the water in the basin of the drain pan 100 reaches the threshold level.

The refrigerant sensor 430 is a circuit configured to detect the presence of refrigerant in air. It can be configured to identify a quantifiable level of refrigerant in the nearby air, or it can be configured to identify when the level of refrigerant in the nearby air rises above the threshold refrigerant level in various embodiments. In an embodiment in which the refrigerant is an A2L refrigerant, the refrigerant sensor 430 is an A2L refrigerant sensor.

The refrigerant sensor 430 will also have some sort of communication capability with the air conditioner controller (e.g., a wired connection or a wireless connection) to allow it to communicate the refrigerant level to the air conditioner controller. Although this is not shown explicitly in FIG. 4, its details should be easily understood.

The refrigerant sensor 430 is connected to the float housing 310 by refrigerant pipe 420, which may be a rigid or a flexible pipe.

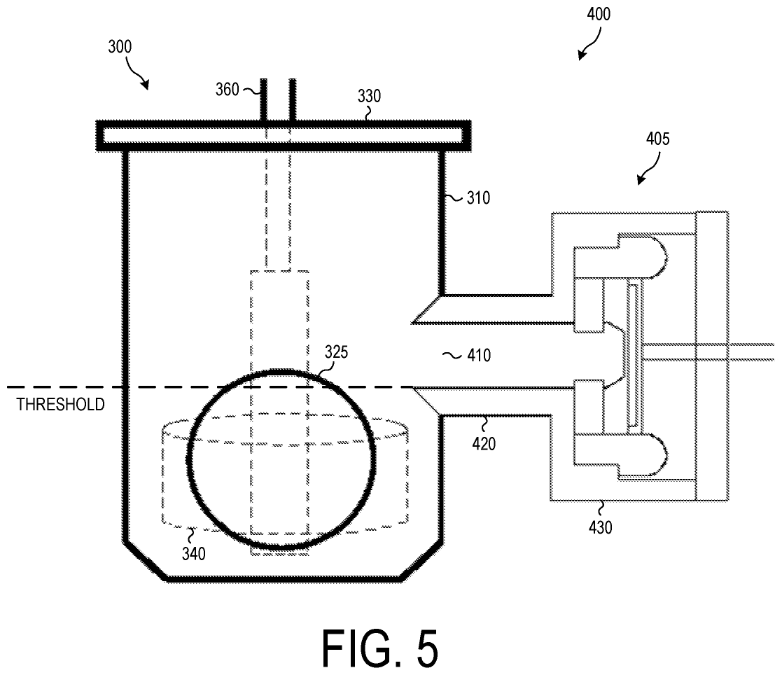

FIG. 5 is a side view of the sensor circuit 400 of FIG. 4 at a first water level according to disclosed embodiments. As shown in FIG. 5, the float sensor 300 and the refrigerant sensor 405 are integrally connected. Specifically, the refrigerant sensor circuit 430 in the refrigerant sensor 405 is connected to an opening 410 in a wall of the float housing 310 via the refrigerant pipe 420. In this way, air in the float housing 310 can pass to the refrigerant sensor circuit 430 through the opening 410 and the refrigerant pipe 430. Since the air in the float housing 310 comes from the drain pan 100, the air received by the refrigerant sensor circuit 430 corresponds to the air above the drain pan 100. Thus, the refrigerant sensor circuit 430 can detect the presence of refrigerant in the air proximate to the drain pan 100.

The opening 410 is positioned such that it is above the threshold level for the float switch 350. Since the float switch 350 instructs the air conditioner to shut off operation when the water in the float housing 310 reaches the threshold level, this threshold level should represent a maximum level of water in the float housing 310. Furthermore, since the opening 410 is located above the threshold level, the water in the float housing 310 should never rise to a level at which it will pass through the opening 410 and to the refrigerant sensor 430. As a result, the sensor circuit 400 prevents water from reaching the sensor circuit 430 and damaging it.

Although in the embodiment of FIG. 4 the opening 410 that connects to the refrigerant pipe 420 is shown as being on a different wall of the float housing 310 from the opening 325 that connects to the overflow pipe 320, this is by way of example only. In alternate embodiments, the opening 410 can be placed on any wall of the float housing 320, including the wall, which the opening 325 is placed.

The water in the float housing 310 in FIG. 5 is at a first water level well below the threshold level. As a result, the float 340 is also well below both the threshold level and the opening 410. In this position, the float switch 350 is off, the shut-off signal is not being sent, and no water can leak into the sensor circuit 430 through the opening 410 and the refrigerant pipe 420.

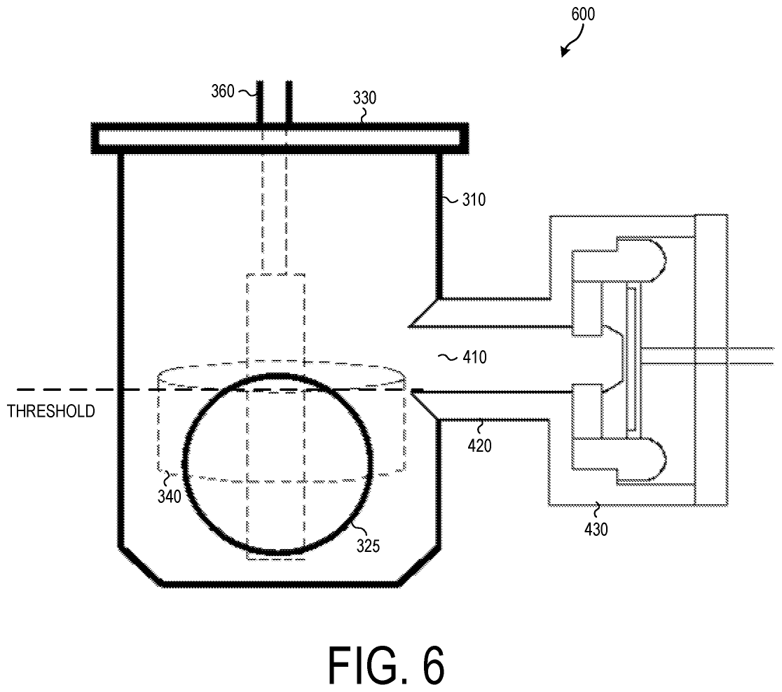

FIG. 6 is a side view of the sensor circuit 400 of FIG. 4 at a second water level according to disclosed embodiments. As shown in FIG. 6, the second water level is higher than the first water level from FIG. 5. Specifically, the second water level is at the threshold level that turns on the float switch 350.

At the second water level, the float 340 has risen to the level where it activates the float switch 350. In this case, the float switch 350 turns on and sends the shut-off signal to the air conditioner controller. In response, the air conditioner controller shuts off the air conditioner, which stops refrigerant from flowing through the coils of the heat exchanger. This likewise stops condensation from forming in the air conditioner and so stops any further flow of water into the float housing 310. As a result, the water level in the float housing 310 should not rise any farther above the second level. Since the second level (i.e., the threshold level) is still below the height of the opening 410, no water should flow through the opening 410 and the refrigerant pipe 420 to the refrigerant sensor 430. This means that even at the highest water level that the float housing 310 will have, the refrigerant sensor 430 will still be protected from water damage.

In various embodiments, the position of the opening 410 and the corresponding threshold level for the float housing 310 can be set such that the distance between the threshold level and the bottom of the opening 410 allows for a certain level of tilt for the float housing 310. Since the surface of the water will remain parallel to the ground, when the float housing 310 tilts, the water may rise closer to the opening 410. To prevent water from passing through the opening 410 and the refrigerant pipe 420 to the refrigerant sensor 430, the threshold level should be placed a distance below the bottom of the opening 410 such that it will still remain below the opening 410 even when tilted.

However, a positive tilt (i.e., to the right as viewed in FIGS. 5-7) can be beneficial for refrigerant detection. The greater the positive tilt, the easier it is for refrigerant, which is typically heavier than air, to flow through the opening 410 and refrigerant pipe 420 to reach the refrigerant sensor 430. Therefore, it may be desirable to have some positive tilt in the positioning of the refrigerant sensor circuit 405.

In one embodiment, the position of the opening 410 and the threshold level are set such that they allow the float housing 310 to be tilted between −5° and 20° while still maintaining no water leakage into the refrigerant sensor 430. However, the acceptable angle tilt is not limited to this range. Alternate embodiments can vary the position of the opening 410 and the threshold level to accommodate any desired permissible angular rotation. The permissible angular rotation can be identified to those who maintain and install the air conditioner such that they will maintain an acceptable position for the sensor circuit 400.

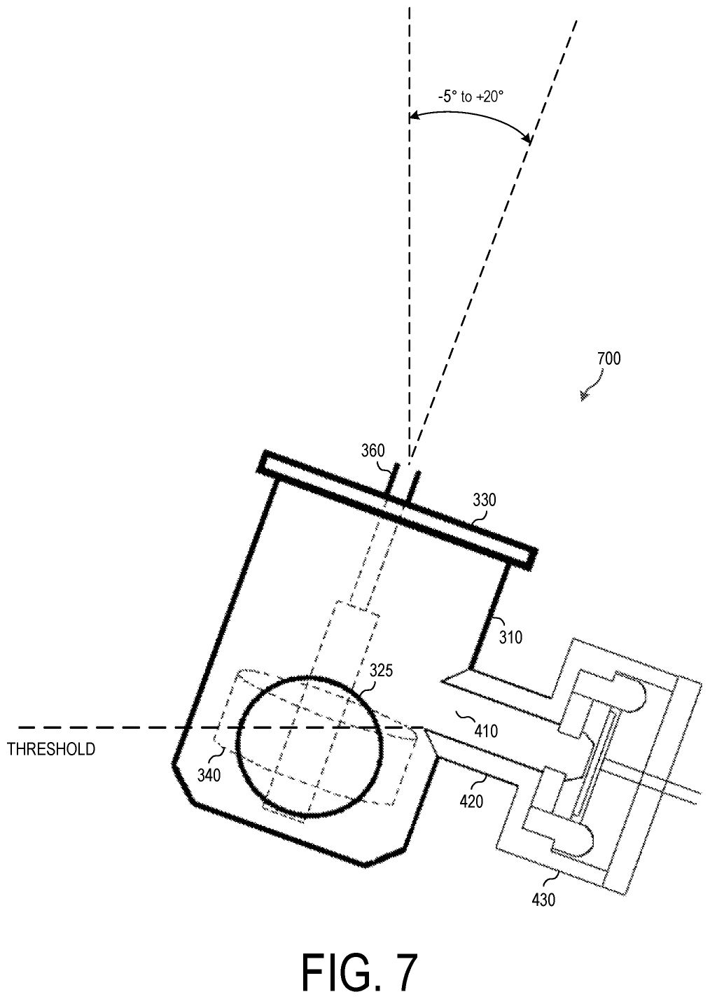

FIG. 7 is a side view of a sensor circuit 700 that is tilted at a positive angle according to disclosed embodiments. Specifically, the sensor circuit 700 in FIG. 7 is tilted at a positive angle of 20°. As shown in FIG. 7, position of the opening 410 and the threshold level in the sensor circuit 700 must be selected in this embodiment such that even when the sensor circuit 400 is tilted at an angle of 20°, the threshold level will not reach the bottom of the opening 410.

In this way, the sensor circuit 700 can be designed to allow for some angular rotation of the sensor circuit 700 while still preventing any water from passing though the opening 410 and the refrigerant pipe 420 into the refrigerant sensor 430.

### Sensor Circuit—Second Embodiment

In an alternate embodiment, the refrigerant sensor circuit 405 is not connected directly to the float sensor 300 but both the float sensor 300 and the refrigerant sensor circuit 405 are connected to the overflow drain 170 of the drain pan 100 via a T-shaped connection pipe.

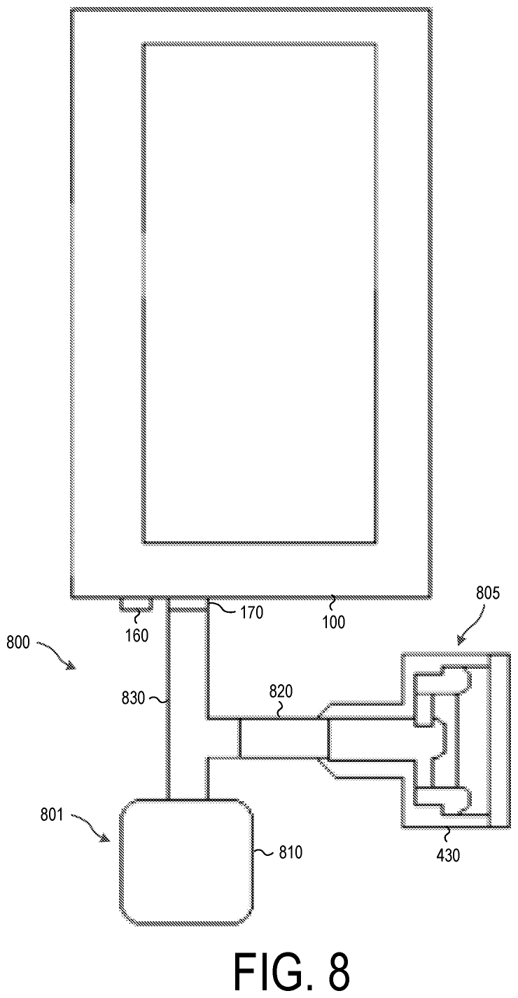

FIG. 8 is a top view of a sensor circuit 800 connected to a drain pan 100 according to disclosed embodiments. As shown in FIG. 8, the sensor circuit 800 includes a float sensor 801, a refrigerant sensor 805, and a connection pipe 830. The refrigerant sensor circuit 805 includes a refrigerant pipe 820 and a refrigerant sensor 430.

The float sensor 801 corresponds to the float sensor 300 of FIGS. 3-7, save that its float housing 810 only contains a single opening 325 to accommodate the connection pipe 830 and does not contain an opening 410 to connect to the refrigerant sensor 805, and the overflow pipe 320 is replaced by the connection pipe 830. The internal configuration and exterior connections of the float sensor 801 corresponds to the internal configuration and exterior connections of the float sensor 300 of FIG. 3. As a result, a description of this internal configuration and exterior connections will be omitted for brevity. Alternate embodiments could retain the overflow pipe 320, in which case the overflow pipe 320 would be located between the float housing 810 and the connection pipe 830.

The connection pipe 830 connects between the overflow drain 170 of the drain pan 100, the float sensor 801, and the refrigerant sensor 805. The connection pipe 830 is configured to pass both water and air to the float sensor 801 and only air to the refrigerant sensor 805.

The refrigerant sensor 430 corresponds to the refrigerant center 430 described above with respect to FIGS. 4-7. A detailed description of the refrigerant sensor 430 will therefore be omitted here for the sake of brevity.

The refrigerant pipe 820 is connected between the connection pipe 830 and the refrigerant sensor 430 and serves to pass air between the connection pipe 830 and the refrigerant sensor 430. In the embodiment of FIG. 8, the refrigerant pipe 820 is tilted upward such that air can pass through it freely but water will collect at the bottom. In this way, the embodiment can prevent water damage to the refrigerant sensor 430.

In operation, water and air will flow from the overflow drain 170 through the connection pipe 830 to the float housing 810, where the float sensor 801 will detect whether or not the water has reached a threshold level and send a shut-off signal as necessary. Likewise, air alone will flow from the overflow drain 170 through the connection pipe 830 and the refrigerant pipe 820 to the refrigerant sensor 430 where the refrigerant sensor 430 will detect a level of refrigerant in the air and will notify the air conditioner controller as necessary.

In a general installation environment, the connection pipe, float sensor 801, and refrigerant sensor 805 will be connected outside of a housing for the air conditioner.

Although the refrigerant pipe 820 is shown, it may be omitted in some embodiments and the connection pipe 830 may be connected directly to the refrigerant sensor 430.

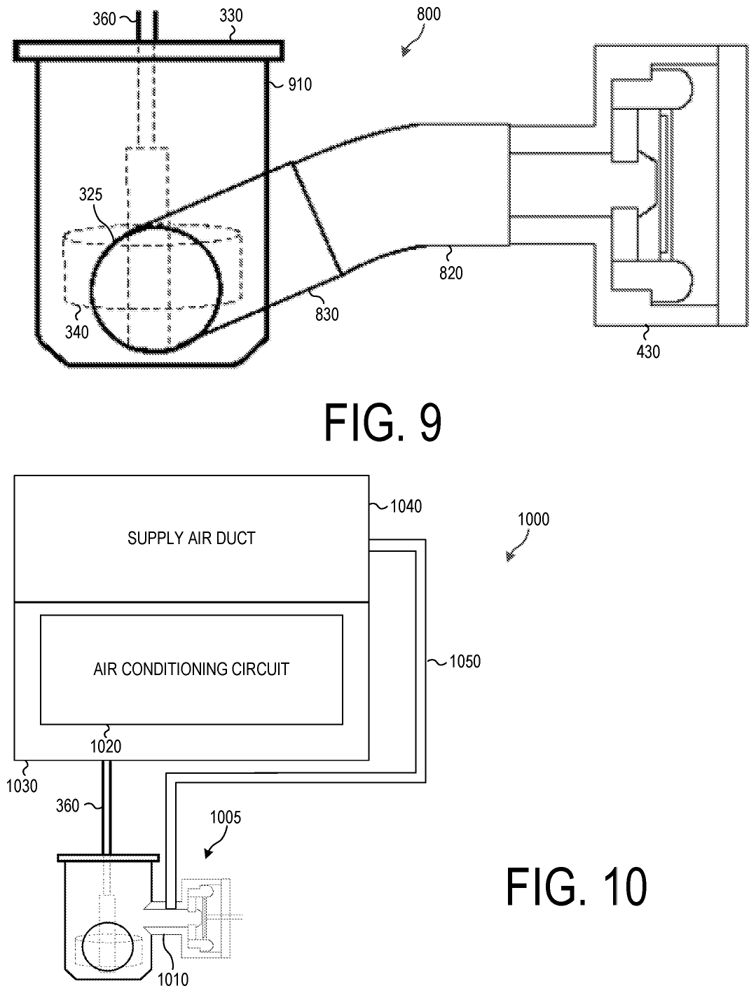

FIG. 9 is a side view of the sensor circuit 800 of FIG. 8 at a first water level according to disclosed embodiments.

As shown in FIG. 9, both the refrigerant pipe 820 and the port in the connection pipe 830 attached to the refrigerant pipe 820 are tilted upward from the remainder of the connection pipe 830 toward the refrigerant sensor 430. The tilt of the this portion of the connection pipe 830 is sufficient that an opening from the refrigerant pipe 820 into the refrigerant sensor is entirely above the threshold level used by the float sensor 801.

As a result of this configuration, water will settle in the portion of the connection pipe 830 between the overflow drain 170 and the float sensor 801. Even when the water in the connection pipe reaches its maximum level (i.e., the threshold level), the water in the connection pipe 830 will still be below the opening that leads from the refrigerant pipe 820 into the refrigerant sensor 430. Therefore, the refrigerant sensor 430 is protected from water damage.

Alternate embodiments can provide different connections between the connection pipe 830 and the refrigerant sensor 430. For example, in one alternate embodiment the port of the connection pipe 830 that connects to the refrigerant sensor circuit 805 could extend vertically upward from the remainder of the connection pipe 830, the refrigerant pipe 820 could extend horizontally from the refrigerant sensor 430, and the connection pipe 830 and the refrigerant pipe 820 could connect above the remainder of the connection pipe 830. Similarly, the port of the connection pipe 830 the connection to the refrigerant sensor circuit 805 could extend horizontally from the remainder of the connection pipe toward the refrigerant sensor 430. The refrigerant pipe 820 could then be L-shaped, connecting to the refrigerant sensor 430 at the top of the L and connecting it to the connection pipe 830 at the bottom of the L. Other possible configurations may be provided.

### Sensor Circuit—Additional Embodiments

Although the embodiments of FIGS. 4-9 all show refrigerant sensors 430 that received air only from the drain pan 100 via the overflow port 170, alternate embodiments could add additional connections.

FIG. 10 is a diagram of an air conditioner 1000 including a sensor circuit 1005 according to disclosed embodiments. As shown in FIG. 10, the air conditioner 1000 includes a sensor circuit 1005, an air conditioning circuit 1020, a housing 1030, a supply air duct 1040, and a first air pipe 1050.

The sensor circuit 1005 operates as the sensor circuit 400 from FIG. 4 save that the refrigerant pipe 420 is replaced with a refrigerant pipe 1010, which is also connected to the first air pipe 1050. A description of the remaining elements will be omitted for the sake of brevity.

The signal line 360 from the sensor circuit 1005 is connected to the air conditioner 1000 to provide the shut-off signal to an air conditioner controller (not shown). Although not explicitly shown in FIG. 10, a float housing in the sensor circuit 1005 is connected to the overflow drain 170 of a drain pan 100 in the air conditioner circuit 1020, as is a refrigerant sensor in sensor circuit 1005.

The air conditioning circuit 1020 may perform all the functions of an air conditioner, including performing a heating and cooling operation. It may operate as an air handler, an A-coil circuit, or any other type of air conditioner circuit that uses refrigerant. The air conditioning circuit 1020 may include a heat exchanger, a fan, a drain pan, and an air conditioner controller. In the embodiment of FIG. 10, the fan is located between the supply air duct 1040 and a heat exchanger. This makes the air conditioner 1000 a pull-through device in which the fan circulates air through the air conditioner 1000 by pulling air from the heat exchanger and providing it to the supply air duct 1040.

The housing 1030 surrounds at least the air conditioning circuit 1020 and serves to protect the air conditioning circuit 1020. The sensor circuit 1005 and the first air pipe 1050 are located outside of the housing 1030.

The supply air duct 1040 receives supply air from a fan in the air conditioner 1000 and so has a pressure higher than a pressure at the drain pan from which point the fan draws in air. These pressures can be a combination of dynamic and static pressures.

The first air pipe 1050 is connected between the supply air duct 1040 and the refrigerant pipe 1010. Specifically, the refrigerant pipe 1010 receives air both from the drain pan 100 in the air conditioning circuit 1020 and from the supply air duct 1040 via the first air pipe 1050. Since the total pressure at the supply air duct 1040 is higher than the total pressure at the sensor circuit 1005, air will flow from the supply air duct 1040 to the sensor circuit 1005 without the need for a separate fan or similar device.

The air received from the supply air duct 1040 will be mixed with the air received from the drain pan prior to being provided to a refrigerant sensor 430. In this way refrigerant sensor 430 can detect refrigerant in both the air proximate to the drain pan and air proximate to the supply air duct 1040.

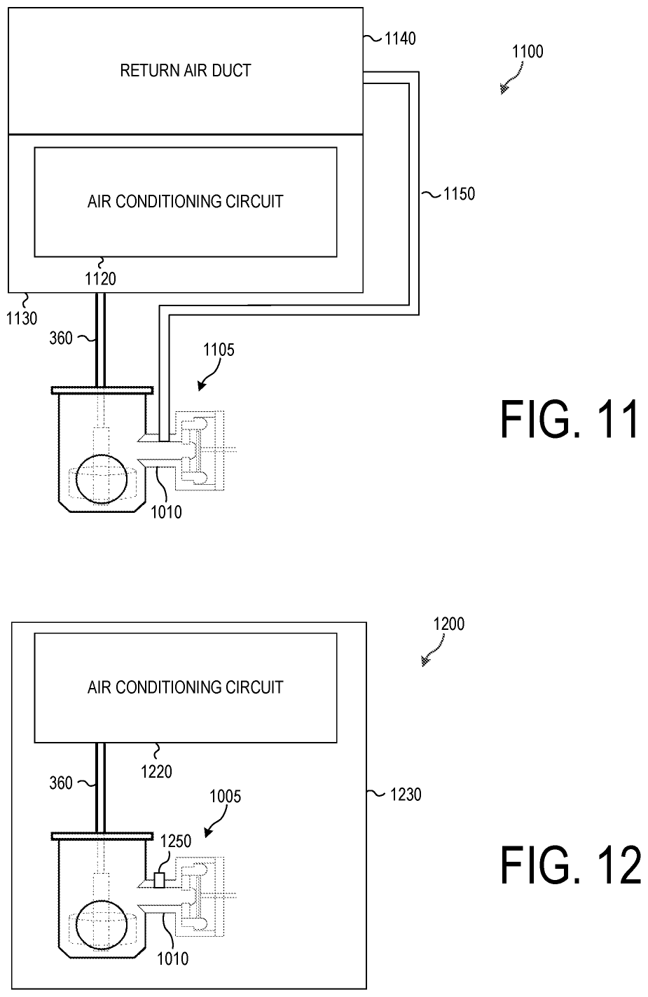

FIG. 11 is a diagram of an air conditioner 1100 including a sensor circuit 1005 according to alternate disclosed embodiments. As shown in FIG. 11, the air conditioner 1100 includes a sensor circuit 1005, an air conditioning circuit 1120, a housing 1130, a return air duct 1140, and a second air pipe 1150.

The sensor circuit 1005 operates as the sensor circuit 1005 from FIG. 10 save that the refrigerant pipe 1010 is connected to the second air pipe 1150. A description of the remaining elements will be omitted for the sake of brevity.

The signal line 360 from the sensor circuit 1005 is connected to the air conditioner 1100 to provide the shut-off signal to an air conditioner controller (not shown). Although not explicitly shown in FIG. 11, a float housing in the sensor circuit 1005 is connected to the overflow drain 170, as is a refrigerant sensor 430 in sensor circuit 1005.

The air conditioning circuit 1120 may perform all the functions of an air conditioner, including a heating and cooling operation. It may operate as an air handler, an A-coil circuit, or any other type of circuit that uses refrigerant. The air conditioning circuit 1120 may include a heat exchanger, a fan, a drain pan, and an air conditioner controller. In this embodiment, the fan is located between the return air duct 1140 and a heat exchanger. This makes the air conditioner 1000 a push-through device in which the fan circulates air through the air conditioner 1000 by pushing air over the heat exchanger from the return air duct 1140.

The housing 1030 surrounds at least the air conditioning circuit 1020 and serves to protect the air conditioning circuit 1020. The sensor circuit 1005 and the second air pipe 1150 are located outside of the housing 1030.

The return air duct 1140 provides return air to the fan in the air conditioning circuit 1120 and so has a total pressure lower than a total pressure at the drain pan 100 where the fan pushes the air. This total pressure can be a combination of dynamic and static pressure.

The second air pipe 1150 is connected between the return air duct 1140 and the refrigerant pipe 1010. Thus, the refrigerant pipe 1010 receives air from the drain pan 100 in the air conditioning circuit 1120 and the second air pipe 1150 draws air from the refrigerant pipe 1010 and provides it to the return air duct 1140. Since the total pressure at the return air duct 1140 is lower than the total pressure at the sensor circuit 1005, air will flow from the sensor circuit 1005 to the return air duct 1140 without the need for a separate fan or similar device.

Since air is drawn from the refrigerant pipe 1010 before it is provided to the refrigerant sensor 430, this will keep the air in the refrigerant pipe 1010 from getting stagnant and will continually draw air in from the drain pan 100. Furthermore, drawing air out of the refrigerant pipe 1010 into the second air pipe 1050 will cause air from the drain pan 100 to flow into the refrigerant pipe 1010 more quickly. This can provide for a more accurate detection of refrigerant in the air by maintaining a steady air flow to the refrigerant sensor 430.

FIG. 12 is a diagram of an air conditioner 1200 including a sensor circuit 1005 according to additional alternate disclosed embodiments. As shown in FIG. 12, the air conditioner 1200 includes a sensor circuit 1005, an air conditioning circuit 1220, a housing 1230, and a third air pipe 1250.

The sensor circuit 1005 operates as the sensor circuit 1005 from FIG. 10 save that the refrigerant pipe 1010 is connected to the third air pipe 1250. A description of the remaining elements will be omitted for the sake of brevity.

The signal line 360 from the sensor circuit 1005 is connected to the air conditioner 1200 to provide the shut-off signal to an air conditioner controller (not shown). Although not explicitly shown in FIG. 12, a float housing in the sensor circuit 1005 is connected to the overflow drain 170, as is a refrigerant sensor 430 in sensor circuit 1005.

The air conditioning circuit 1220 may perform all the functions of an air conditioner, including a heating and cooling operation. It may operate as an air handler, an A-coil circuit, or any other type of circuit that uses refrigerant. The air conditioning circuit 1220 may include a heat exchanger, a fan, a drain pan, and an air conditioner controller. In this embodiment, the fan may be located anywhere and the air conditioner 1200 may be a push-through device or a pull-through device.

The housing 1230 surrounds at least the air conditioning circuit 1220 and serves to protect the air conditioning circuit 1220. The sensor circuit 1005 and the third air pipe 1250 are located outside of the housing 1230.

The third air pipe 1250 is connected to the refrigerant pipe 1010 and opens the refrigerant pipe 1010 to the air outside of the refrigerant sensor 430. The refrigerant pipe 1010 receives air from the drain pan in the air conditioning circuit 1220 and that air can mix with the air immediately outside of the refrigerant pipe 1010 before being provided to the refrigerant sensor 430.

Since the air in the refrigerant pipe 1010 can mix with outside air before it is provided to the refrigerant sensor 430, this will keep the air in the refrigerant pipe 1010 from getting stagnant. It will also allow the refrigerant sensor 430 to sample air proximate to the refrigerant sensor 430, not just air from the drain pan 100. This can provide for a more accurate detection of refrigerant in the air by maintaining a steady air flow to the refrigerant sensor 430.

Although the embodiments of FIGS. 10-12 show the first, second, and third air pipes 1050, 1150, 1250 as being connected to the refrigerant pipe 1010, this is by way of example only. Alternate embodiments could have the connected to a first, second, and third air pipes 1050, 1150, 1250 to a float housing, to a connection pipe between a float housing or a refrigerant sensor 430 and the drain pan, to a refrigerant sensor 430 directly, or any other portion of an air conditioner 1000, 1100, 1200 that would allow for proper mixing or drawing of air.

### Methods of Operation

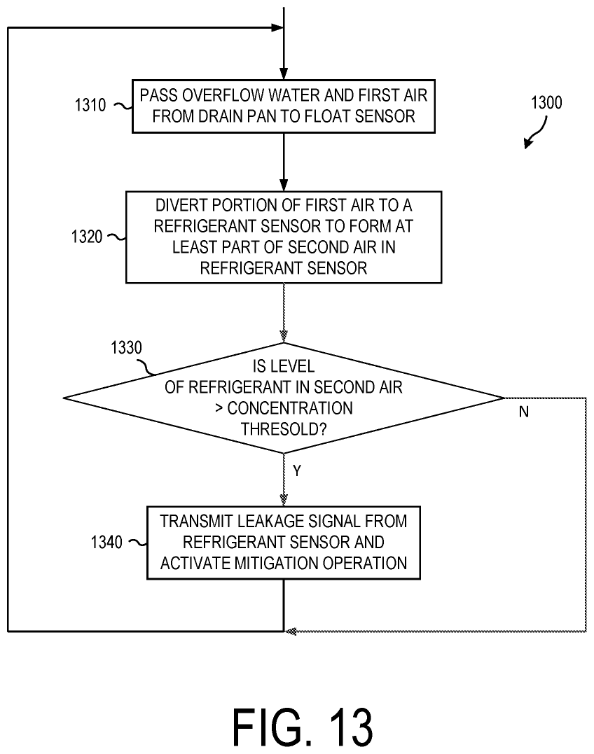

FIG. 13 is a flow chart 1300 of a method of sensing a refrigerant according to disclosed embodiments.

As shown in FIG. 13, the operation begins by passing overflow water and first air from a drain pan to a float sensor. (1310)

A portion of the first air is then diverted to a refrigerant sensor to form at least part of second air in the refrigerant sensor. (1320)

The refrigerant sensor then determines whether a level of refrigerant in the second air is greater than a set concentration threshold. (1330)

If the refrigerant sensor determines that the level of refrigerant in the second air is greater than the set concentration threshold, it transmits a leakage signal from the refrigerant sensor and activates a mitigation operation. (1340)

If, however, the refrigerant sensor determines that the level of refrigerant in the second air is not greater then the set concentration level threshold, it does not transmit any signal and returns to passing overflow water and first air from a drain pan to the float sensor (1310).

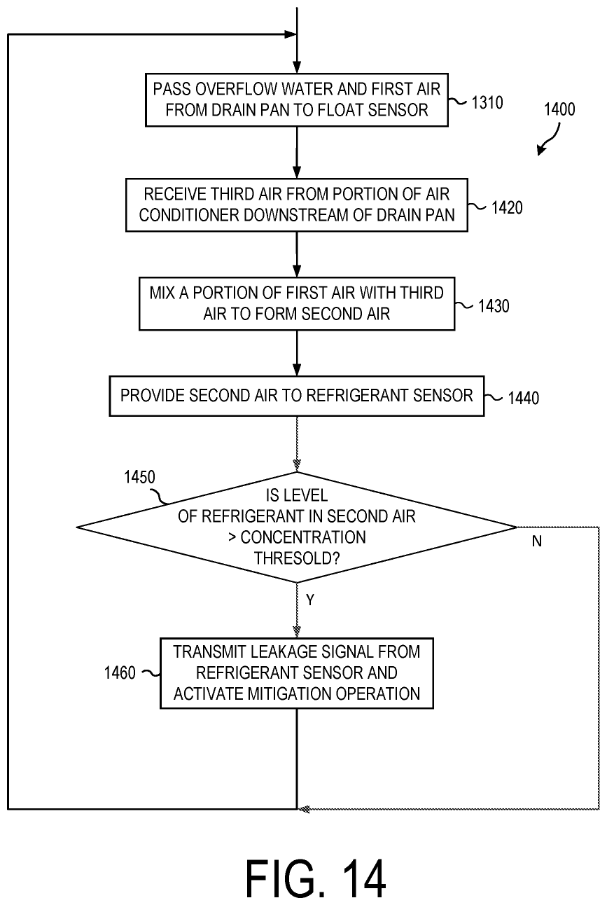

FIG. 14 is a flow chart 1400 of a method of sensing a refrigerant according to alternate disclosed embodiments.

As shown in FIG. 14, the operation begins by passing overflow water and first air from a drain pan to a float sensor. (1310)

The system then receives third air from portion of air conditioner downstream of the drain pan, which has a higher total pressure than a total pressure of the first air received from the drain pan. (1420)

A portion of the first air is then mixed with the third air to form second air. (1430)

The second air is provided to a refrigerant sensor. (1440)

The refrigerant sensor then determines whether a level of refrigerant in the second air is greater than a set concentration threshold. (1450)

If the refrigerant sensor determines that the level of refrigerant in the second air is greater than the set concentration threshold, it transmits a leakage signal from the refrigerant sensor and activates a mitigation operation. (1460)

If, however, the refrigerant sensor determines that the level of refrigerant in the second air is not greater then the set concentration level threshold, it does not transmit any signal and returns to passing overflow water and first air from a drain pan to the float sensor (1310).

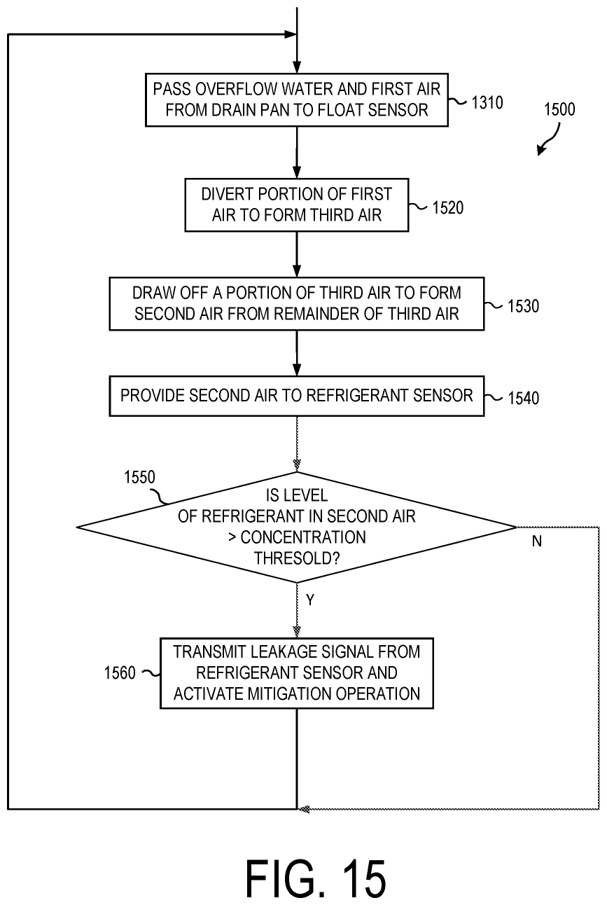

FIG. 15 is a flow chart 1500 of a method of sensing a refrigerant according to other alternate disclosed embodiments.

As shown in FIG. 15, the operation begins by passing overflow water and first air from a drain pan to a float sensor. (1310)

A portion of the first air is then diverted to form third air. (1520)

A portion of the third air is then drawn off and second air is formed from the remainder of the third air. (1430)

The second air is then provided to a refrigerant sensor. (1540)

The refrigerant sensor then determines whether a level of refrigerant in the second air is greater than a set concentration threshold. (1550)

If the refrigerant sensor determines that the level of refrigerant in the second air is greater than the set concentration threshold, it transmits a leakage signal from the refrigerant sensor and activates a mitigation operation. (1560)

If, however, the refrigerant sensor determines that the level of refrigerant in the second air is not greater then the set concentration level threshold, it does not transmit any signal and returns to passing overflow water and first air from a drain pan to the float sensor (1310).

### CONCLUSION

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled. The various circuits described above can be implemented in discrete circuits or integrated circuits, as desired by implementation.

1. A sensor circuit, comprising:
a float sensor including
a float housing having an opening on a first side wall, the float housing being configured to contain a liquid, such that the liquid can flow into and out of the float housing through the opening,
a float located in the float housing and configured to rise or fall based on a level of the liquid in the float housing, and
a switch connected to the float and configured to transmit an air-conditioner shut-down signal when the liquid in the float housing rises to a predetermined height; and
a refrigerant sensor circuit connected to the float sensor, the refrigerant sensor circuit including a refrigerant sensor and being configured to detect a level of refrigerant in second air formed at least in part from first air in the float housing,
wherein
the refrigerant pipe is connected to a second wall of the float housing at a location fully above the predetermined height.

2. The sensor circuit in claim 1, wherein
the first air is provided to the refrigerant sensor as the second air.

3. The sensor circuit in claim 1, wherein
the refrigerant sensor circuit further includes a refrigerant pipe connected at a first end to a second wall of the float housing and at a second end to the refrigerant sensor, the refrigerant pipe being configured to allow the first air from the float housing to pass through to the refrigerant sensor.

4. The sensor circuit in claim 3, further comprising:
an air pipe connected at a first end to the refrigerant pipe such that the first air passing into the refrigerant pipe from the float sensor and third air passing into the refrigerant pipe through the air pipe are mixed in the refrigerant pipe to create the second air prior to the second air being provided to the refrigerant sensor.

5. The sensor circuit in claim 3, further comprising:
an air pipe connected at a first end to the refrigerant pipe such that a portion of the first air passing into the refrigerant pipe from the float sensor is passed as third air through the air pipe, and a remainder of the first air after the third air is removed forms the second air prior to the second air being provided to the refrigerant sensor.

6. The sensor circuit in claim 1, wherein
the float sensor further includes an overflow pipe connected at a first end to the first side wall of the float housing such that the liquid can flow from the overflow pipe into and out of the float housing through the opening.

7. The sensor circuit in claim 6, wherein
a second end of the overflow pipe is connected to an overflow port in a drain pan in an air conditioner,
the drain pan is contained inside an air-conditioner housing, and
the sensor circuit is located outside of the air-conditioner housing.

8. A sensor circuit, comprising:
a float sensor including
a float housing having an opening on a first side wall, the float housing being configured to contain a liquid,
a float located in the float housing and configured to rise or fall based on a level of the liquid in the float housing, and
a switch connected to the float and configured to transmit an air-conditioner shut-down signal when the liquid in the float housing rises to a predetermined height;
a three-way connection pipe connected at a first end to the first side wall of the float housing such that the liquid and first air can flow from the overflow pipe into the float housing through the opening; and
a refrigerant sensor connected to a third end of the three-way connection pipe and configured to detect a level of refrigerant in third air formed at least in part by the first air in the three-way connection pipe,
wherein
an opening from the third end of the three-way connection pipe is located above the predetermined height.

9. The sensor circuit in claim 8, wherein
the three-way connection pipe includes
a three-way main pipe having first, second, and third ends, and
a float-switch pipe connected between the second end of the three-way main pipe and the first side wall of the float housing such that the liquid can flow from the float-switch pipe into the float housing through the opening.

10. The sensor circuit in claim 9, wherein
the three-way connection pipe further includes
a refrigerant-sensor pipe connected between the third end of the three-way main pipe and the refrigerant sensor such that the first air in the three-way connection pipe is passed through the refrigerant-sensor pipe to the refrigerant sensor.

11. The sensor circuit in claim 8, wherein
the three-way connection pipe further includes
a three-way main pipe having first, second, and third ends, and
a refrigerant-sensor pipe connected between the third end of the three-way main pipe and the refrigerant sensor such that the first air in the three-way connection pipe is passed through the refrigerant-sensor pipe to the refrigerant sensor.

12. The sensor circuit in claim 8, wherein
the third end of the three-way connection pipe is connected to an overflow port in a drain pan in an air conditioner,
the drain pan is contained inside an air-conditioner housing, and
the sensor circuit is located outside of the air-conditioner housing.

13. The sensor circuit in claim 8, further comprising:
an air pipe connected at a first end to the three-way connection pipe such that the first air passing into the three-way connection pipe and third air passing into the refrigerant pipe through the air pipe are mixed in the refrigerant pipe to create the second air prior to the second air being provided to the refrigerant sensor.

14. A method of detecting refrigerant, comprising:
passing overflow water and first air from a drain pan in an air conditioner to a float sensor;
diverting a portion of the first air to a refrigerant sensor to form at least part of second air in the refrigerant sensor after the air exits the drain pan;
determining at the refrigerant sensor that a level of refrigerant in the second air is above a concentration threshold; and
transmitting a leakage signal from the refrigerant sensor after the refrigerant sensor determines that the level of refrigerant in the second air is above the concentration threshold.

15. The method of claim 14, further comprising
passing third air from a portion of the air conditioner downstream of the drain pan to the refrigerant sensor; and
mixing the first air and the third air to form the second air.

16. The method of claim 15, wherein
the passing of the third air from the portion of the air conditioner downstream of the drain pan to the refrigerant sensor is accomplished based on a third air pressure of the third air in the portion of the air conditioner downstream of the drain pan being greater than a first air pressure of the first air provided from the drain pan.

17. The method of claim 15, wherein
the mixing the first air and the third air to form the second air is performed in a pipe between the drain pan, refrigerant sensor, and the portion of the air conditioner downstream of the drain pan.

18. The method of claim 14, further comprising:
drawing a portion of the first air from the refrigerant sensor to a portion of the air conditioner downstream of the drain pan.

19. The method of claim 14, wherein in the operation of diverting a portion of the first air to the refrigerant sensor, the portion of the first air is diverted to the refrigerant sensor after the portion of first air enters the float sensor.

20. The method of claim 14, wherein
the operation of passing the overflow water and the first air from the drain pan to the float sensor further includes
passing the overflow water and the first air from the drain pan to a three-way connection pipe, and
passing the first water and the overflow air from the three-way connection pipe to the float sensor, and
in the operation of diverting the portion of the first air to the refrigerant sensor, the first air is diverted from the three-way connection pipe to the refrigerant sensor before the first air is provided to the float sensor.
